(19) United States
(12) Patent Application Publication
(10) Pub. No.: US 2020/0307573 A1
(43) Pub. Date: Oct. 1, 2020

(54) VEHICLE CONTROL SYSTEM

(71) Applicant: HONDA MOTOR CO., LTD., Tokyo (JP)

(72) Inventors: Daichi KATO, Wako-shi (JP); Kanta TSUJI, Wako-shi (JP); Tadashi NARUSE, Wako-shi (JP)

(21) Appl. No.: 16/832,849

(22) Filed: Mar. 27, 2020

(30) Foreign Application Priority Data
Mar. 28, 2019 (JP) 2019062169

(51) Int. Cl. B60W 30/09; B60W 10/20; G05D 1/02; B60W 30/095; B60W 60/00

(52) U.S. Cl. CPC B60W 30/09; B60W 10/20; B60W 60/0016; B60W 30/0956; B60W 60/0027; G05D 1/0214

(57) ABSTRACT

In a vehicle control system (1, 101), a control unit (15) acquires a position and a speed of the obstacle according to a signal from an external environment recognition device (6), computes a position of the obstacle at each of a plurality of time points in future, and an obstacle presence region defined around the object with a prescribed safety margin at each time point, determines a future target trajectory of the vehicle so as not to overlap with the obstacle presence region, and executes a stop process to bring the vehicle to a stop in a prescribed stop area when an input from the driver has failed to be detected in spite of an intervention request from the control system to the driver, the safety margin being greater when executing the stop process than when not executing the stop process.

### TECHNICAL FIELD

The present invention relates to a vehicle control system configured for autonomous driving.

### BACKGROUND ART

According to a known vehicle control system, when the driver has lost consciousness, the vehicle is caused to come to a stop in a place that does not obstruct the traffic. See WO2013/008299A1, for instance. According to this prior art, when the vehicle is about to be brought to a stop, the control system chooses a spot that avoids an intersection or a railway crossing, and keeps the vehicle parked at this spot.

If a vehicle is brought to a stop in a right-turn lane in a left-hand driving region, the traffic can be seriously affected, and a traffic congestion can be caused. Therefore, in such a situation, the vehicle is required to turn right, and to be brought to a spot that does not seriously obstruct the traffic. Such a maneuver may have to be executed while the driver does not or cannot get involved in driving. It is therefore desirable to execute such a maneuver with a minimum risk.

### SUMMARY OF THE INVENTION

In view of such a problem of the prior art, a primary object of the present invention is to provide a vehicle control system configured for autonomous driving that can bring a vehicle to a stop in a stop area with a minimum risk when the driver is not able to intervene in driving.

To achieve such an object, the present invention provides a vehicle control system (1), comprising: a control unit (15) configured to control a vehicle according to a degree of intervention in driving by a driver, the intervention in driving including steering, accelerating, and decelerating vehicle, and monitoring an environment surrounding the vehicle; and an external environment recognition device (6) configured to detect an obstacle located around the vehicle; wherein the control unit acquires a position and a speed of the obstacle according to a signal from the external environment recognition device, computes a position of the obstacle at each of a plurality of time points in future, and an obstacle presence region defined around the object with a prescribed safety margin at each time point, determines a future target trajectory of the vehicle so as not to overlap with the obstacle presence region, and executes a stop process to bring the vehicle to a stop in a prescribed stop area when an input from the driver has failed to be detected in spite of an intervention request from the control system to the driver, the safety margin being greater when executing the stop process than when not executing the stop process.

Since the control unit makes the safety margin greater at the time of executing the stop process than at the time of not executing the stop process, the possibility of collision or a near miss with the obstacle can be further reduced. Thus, the vehicle can travel more safely toward the stop area.

Preferably, in the stop process, the control unit determines the stop area on a planned route to a destination such that the vehicle crosses an oncoming lane no more

Since the number of times the vehicle crosses the oncoming lane is limited, the probability of occurrence of an accident can be further reduced.

Preferably, when the vehicle is traveling in a lane for crossing the oncoming lane, and a stop process is initiated, the control unit determines the stop area in a part of the route beyond the oncoming lane that is to be crossed.

Since the vehicle comes to a stop after leaving the lane for crossing the oncoming lane in the stop process, the possibility of obstructing the traffic in the turning lane can be minimized.

Preferably, the control unit controls a vehicle speed to be slower when the vehicle crosses the oncoming lane in the stop process than when the vehicle crosses the oncoming lane not in the stop process.

Since the vehicle traveling on the oncoming lane is better able to avoid the own vehicle, the possibility of an accident can be further reduced.

Preferably, in executing the stop process, when the vehicle is not in a lane for crossing an oncoming lane, the control unit determines the stop area in a part of the route not crossing the oncoming lane.

Since the vehicle does not take a route crossing the oncoming lane, the probability of occurrence of an accident can be further reduced.

Preferably, in executing the stop process, the control unit determines the stop area in a range on the route to the destination excluding a lane for crossing the oncoming lane.

Thereby, the vehicle is prevented from coming to a stop in the lane for crossing the oncoming lane, and obstructing the traffic of the following vehicles.

Preferably, in executing the stop process, the control unit determines the stop area in a range on the route to the destination such that there is no more than one left turn or one right turn.

Since the number of times the vehicle makes a right or left turn is limited, the probability of the occurrence of an accident can be further reduced.

Preferably, in executing the stop process, when the vehicle is in a lane for turning right or left, the control unit determines the stop area on a part of the road located beyond a part where the vehicle makes a right or left turn.

Since the vehicle comes to a stop after leaving the lane for turning right or left in the stop process, the own vehicle does not obstruct the traffic of other vehicles.

Preferably, in executing the stop process, the control unit determines the stop area in a part of a road along which the vehicle is currently traveling if the vehicle is not in a lane for making a left turn or a right turn.

Since the vehicle does not make a right or left turn, the probability of occurrence of an accident can be further reduced.

Preferably, in executing the stop process, the control unit determines the stop area in a range excluding a lane for the vehicle to make a right or left turn.

Thus, the vehicle can be brought to a stop at a position where the traffic of other vehicles going to make a left-turn or a right-turn is not obstructed.

The present invention thus provides a vehicle control system configured for autonomous driving that can bring a vehicle to a stop in a stop area with a minimum risk when the driver is not able to intervene in driving.

### BRIEF DESCRIPTION OF THE DRAWING(S)

FIG. 1 is a functional block diagram of a vehicle on which a vehicle control system according to the present invention is mounted;

FIG. 2 is a flowchart of a stop process;

FIG. 3 is a diagram illustrating a safety margin and an obstacle presence region defined for each obstacle; and

FIG. 4 is a flowchart of a stop area determination process.

### DESCRIPTION OF THE PREFERRED EMBODIMENT(S)5

A vehicle control system according to a preferred embodiment of the present invention is described in the following with reference to the appended drawings. The following disclosure is according to left-hand traffic. In the case of right-hand traffic, the left and the right in the disclosure will be reversed.

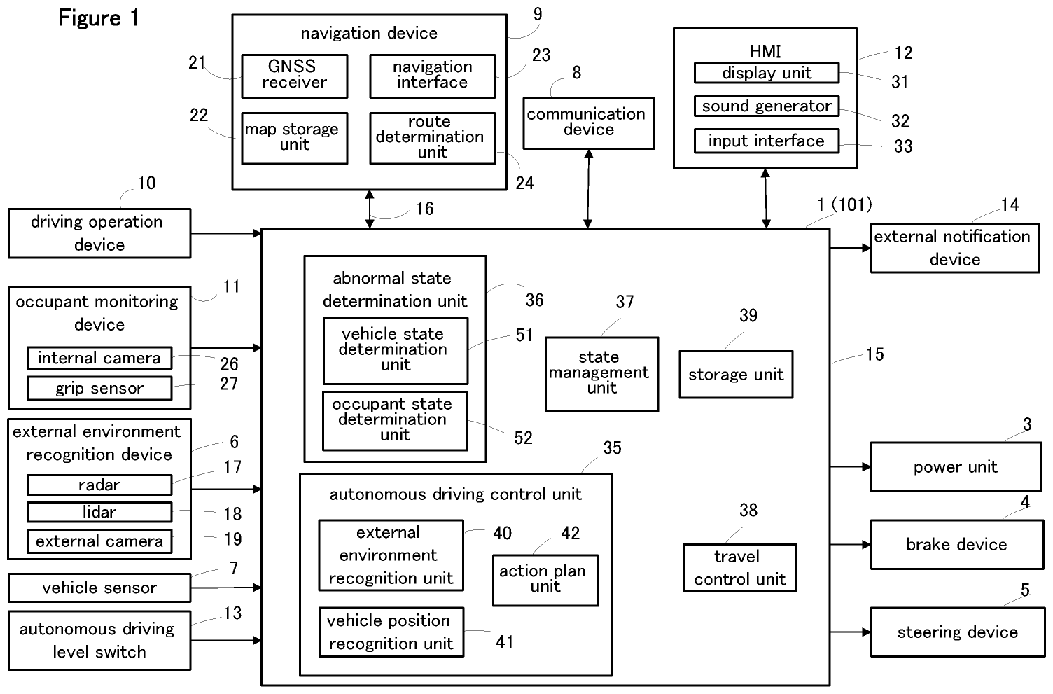

As shown in FIG. 1, the vehicle control system 1 according to the present invention is a part of a vehicle system 2 mounted on a vehicle. The vehicle system 2 includes a power unit 3, a brake device 4, a steering device 5, an external environment recognition device 6, a vehicle sensor 7, a communication device 8, a navigation device 9 (map device), a driving operation device 10, an occupant monitoring device 11, an HMI 12 (Human Machine Interface), an autonomous driving level switch 13, an external notification device 14, and a control unit 15. These components of the vehicle system 2 are connected to one another so that signals can be transmitted between them via a communication means such as CAN 16 (Controller Area Network).

The power unit 3 is a device for applying a driving force to the vehicle, and may include a power source and a transmission unit. The power source may consist of an internal combustion engine such as a gasoline engine and a diesel engine, an electric motor or a combination of these. The brake device 4 is a device that applies a braking force to the vehicle, and may include a brake caliper that presses a brake pad against a brake rotor, and an electrically actuated hydraulic cylinder that supplies hydraulic pressure to the brake caliper. The brake device 4 may also include a parking brake device. The steering device 5 is a device for changing a steering angle of the wheels, and may include a rack-and-pinion mechanism that steers the front wheels, and an electric motor that drives the rack-and-pinion mechanism. The power unit 3, the brake device 4, and the steering device 5 are controlled by the control unit 15.

The external environment recognition device 6 is a device that detects objects located outside of the vehicle. The external environment recognition device 6 may include a sensor that captures electromagnetic waves or light from around the vehicle to detect objects outside of the vehicle, and may consist of a radar 17, a lidar 18, an external camera 19, or a combination of these. The external environment recognition device 6 may also be configured to detect objects outside of the vehicle by receiving a signal from a source outside of the vehicle. The detection result of the external environment recognition device 6 is forwarded to the control unit 15.

The radar 17 emits radio waves such as millimeter waves to the surrounding area of the vehicle, and detects the position (distance and direction) of an object by capturing the reflected wave. Preferably, the radar 17 includes a front radar that radiates radio waves toward the front of the vehicle, a rear radar that radiates radio waves toward the rear of the vehicle, and a pair of side radars that radiates radio waves in the lateral directions.

The lidar 18 emits light such as an infrared ray to the surrounding part of the vehicle, and detects the position (distance and direction) of an object by capturing the reflected light. At least one lidar 18 is provided at a suitable position of the vehicle.

The external camera 19 can capture the image of the surrounding objects such as vehicles, pedestrians, guardrails, curbs, walls, median strips, road shapes, road signs, road markings painted on the road, and the like. The external camera 19 may consist of a digital camera using a solid-state imaging device such as a CCD and a CMOS. At least one external camera 19 is provided at a suitable position of the vehicle. The external camera 19 preferably includes a front camera that images the front of the vehicle, a rear camera that images the rear of the vehicle and a pair of side cameras that image the lateral views from the vehicle. The external camera 19 may consist of a stereo camera that can capture a three-dimensional image of the surrounding objects.

The vehicle sensor 7 may include a vehicle speed sensor that detects the traveling speed of the vehicle, an acceleration sensor that detects the acceleration of the vehicle, a yaw rate sensor that detects an angular velocity of the vehicle around a vertical axis, a direction sensor that detects the traveling direction of the vehicle, and the like. The yaw rate sensor may consist of a gyro sensor.

The communication device 8 allows communication between the control unit 15 which is connected to the navigation device 9 and other vehicles around the own vehicle as well as servers located outside the vehicle. The control unit 15 can perform wireless communication with the surrounding vehicles via the communication device 8. For instance, the control unit 15 can communicate with a server that provides traffic regulation information via the communication device 8, and with an emergency call center that accepts an emergency call from the vehicle also via the communication device 8. Further, the control unit 15 can communicate with a portable terminal carried by a person such as a pedestrian present outside the vehicle via the communication device 8.

The navigation device 9 is able to identify the current position of the vehicle, and performs route guidance to a destination and the like, and may include a GNSS receiver 21, a map storage unit 22, a navigation interface 23, and a route determination unit 24. The GNSS receiver 21 identifies the position (latitude and longitude) of the vehicle according to a signal received from artificial satellites (positioning satellites). The map storage unit 22 may consist of a per se known storage device such as a flash memory and a hard disk, and stores or retains map information. The navigation interface 23 receives an input of a destination or the like from the user, and provides various information to the user by visual display and/or speech. The navigation interface 23 may include a touch panel display, a speaker, and the like. In another embodiment, the GNSS receiver 21 is configured as a part of the communication device 8. The map storage unit 22 may be configured as a part of the control unit 15 or may be configured as a part of an external server that can communicate with the control unit 15 via the communication device 8.

The map information may include a wide range of road information which may include, not exclusively, road types such as expressways, toll roads, national roads, and prefectural roads, the number of lanes of the road, road markings such as the center position of each lane (three-dimensional coordinates including longitude, latitude, and height), road division lines and lane lines, the presence or absence of sidewalks, curbs, fences, etc., the locations of intersections, the locations of merging and branching points of lanes, the areas of emergency parking zones, the width of each lane, and traffic signs provided along the roads. The map information may also include traffic regulation information, address information (address/postal code), facility information, telephone number information, and the like.

The route determination unit 24 determines a route to the destination according to the position of the vehicle specified by the GNSS receiver 21, the destination input from the navigation interface 23, and the map information. When determining the route, in addition to the route, the route determination unit 24 determines the target lane which the vehicle will travel in by referring to the merging and branching points of the lanes in the map information.

The driving operation device 10 receives an input operation performed by the driver to control the vehicle. The driving operation device 10 may include a steering wheel, an accelerator pedal, and a brake pedal. Further, the driving operation device 10 may include a shift lever, a parking brake lever, and the like. Each element of the driving operation device 10 is provided with a sensor for detecting an operation amount of the corresponding operation. The driving operation device 10 outputs a signal indicating the operation amount to the control unit 15.

The occupant monitoring device 11 monitors the state of the occupant in the passenger compartment. The occupant monitoring device 11 includes, for example, an internal camera 26 that images an occupant sitting on a seat in the vehicle cabin, and a grip sensor 27 provided on the steering wheel. The internal camera 26 is a digital camera using a solid-state imaging device such as a CCD and a CMOS. The grip sensor 27 is a sensor that detects if the driver is gripping the steering wheel, and outputs the presence or absence of the grip as a detection signal. The grip sensor 27 may be formed of a capacitance sensor or a piezoelectric device provided on the steering wheel. The occupant monitoring device 11 may include a heart rate sensor provided on the steering wheel or the seat, or a seating sensor provided on the seat. In addition, the occupant monitoring device 11 may be a wearable device that is worn by the occupant, and can detect the vital information of the driver including at least one of the heart rate and the blood pressure of the driver. In this conjunction, the occupant monitoring device 11 may be configured to be able to communicate with the control unit 15 via a per se known wireless communication means. The occupant monitoring device 11 outputs the captured image and the detection signal to the control unit 15.

The external notification device 14 is a device for notifying to people outside of the vehicle by sound and/or light, and may include a warning light and a horn. A headlight (front light), a taillight, a brake lamp, a hazard lamp, and a vehicle interior light may function as a warning light.

The HMI 12 notifies the occupant of various kinds of information by visual display and speech, and receives an input operation by the occupant. The HMI 12 may include at least one of a display device 31 such as a touch panel and an indicator light including an LCD or an organic EL, a sound generator 32 such as a buzzer and a speaker, and an input interface 33 such as a GUI switch on the touch panel and a mechanical switch. The navigation interface 23 may be configured to function as the HMI 12.

The autonomous driving level switch 13 is a switch that activates autonomous driving as an instruction from the driver. The autonomous driving level switch 13 may be a mechanical switch or a GUI switch displayed on the touch panel, and is positioned in a suitable part of the cabin. The autonomous driving level switch 13 may be formed by the input interface 33 of the HMI 12 or may be formed by the navigation interface 23.

The control unit 15 may consist of an electronic control unit (ECU) including a CPU, a ROM, a RAM, and the like. The control unit 15 executes various types of vehicle control by executing arithmetic processes according to a computer program executed by the CPU. The control unit 15 may be configured as a single piece of hardware, or may be configured as a unit including a plurality of pieces of hardware. In addition, at least a part of each functional unit of the control unit 15 may be realized by hardware such as an LSI, an ASIC, and an FPGA, or may be realized by a combination of software and hardware.

The control unit 15 is configured to execute autonomous driving control of at least level 0 to level 3 by combining various types of vehicle control. The level is according to the definition of SAE J3016, and is determined in relation to the degree of machine intervention in the driving operation of the driver and in the monitoring of the surrounding environment of the vehicle.

In autonomous driving of level 0, the control unit 15 does not control the vehicle, and the driver performs all of the driving operations. Thus, autonomous driving of level 0 means a manual driving.

In autonomous driving of level 1, the control unit 15 executes a certain part of the driving operation, and the driver performs the remaining part of the driving operation. For example, autonomous driving level 1 includes constant speed traveling, inter-vehicle distance control (ACC; Adaptive Cruise Control) and lane keeping assist control (LKAS; Lane Keeping Assistance System). The level 1 autonomous driving is executed when various devices (for example, the external environment recognition device 6 and the vehicle sensor 7) required for executing the level 1 autonomous driving are all properly functioning.

In autonomous driving of level 2, the control unit 15 performs the entire driving operation. The level 2 autonomous driving is performed only when the driver monitors the surrounding environment of the vehicle, the vehicle is within a designated area, and the various devices required for performing the level 2 autonomous driving are all functioning properly.

In level 3 autonomous driving, the control unit 15 performs the entire driving operation. The level 3 autonomous driving requires the driver to monitor or be aware of the surrounding environment when required, and is executed only when the vehicle is within a designated area, and the various devices required for performing the level 3 autonomous driving are all functioning properly. The conditions under which the level 3 autonomous driving is executed may include that the vehicle is traveling on a congested road. Whether the vehicle is traveling on a congested road or not may be determined according to traffic regulation information provided from a server outside of the vehicle, or, alternatively, that the vehicle speed detected by the vehicle speed sensor is determined to be lower than a predetermined slowdown determination value (for example, 30 km/h) over a predetermined time period.

Thus, in the autonomous driving of levels 1 to 3, the control unit 15 executes at least one of the steering, the acceleration, the deceleration, and the monitoring of the surrounding environment. When in the autonomous driving mode, the control unit 15 executes the autonomous driving of level 1 to level 3. Hereinafter, the steering, acceleration, and deceleration operations are collectively referred to as driving operation, and the driving and the monitoring of the surrounding environment may be collectively referred to as driving.

In the present embodiment, when the control unit 15 has received an instruction to execute autonomous driving via the autonomous driving level switch 13, the control unit 15 selects the autonomous driving level that is suitable for the environment of the vehicle according to the detection result of the external environment recognition device 6 and the position of the vehicle acquired by the navigation device 9, and changes the autonomous driving level as required. However, the control unit 15 may also change the autonomous driving level according the input to the autonomous driving level switch 13.

As shown in FIG. 1, the control unit 15 includes an autonomous driving control unit 35, an abnormal state determination unit 36, a state management unit 37, a travel control unit 38, and a storage unit 39.

The autonomous driving control unit 35 includes an external environment recognition unit 40, a vehicle position recognition unit 41, and an action plan unit 42. The external environment recognition unit 40 recognizes an obstacle located around the vehicle, the shape of the road, the presence or absence of a sidewalk, and road signs according to the detection result of the external environment recognition device 6. The obstacles include, not exclusively, guardrails, telephone poles, surrounding vehicles, and pedestrians. The external environment recognition unit 40 can acquire the state of the surrounding vehicles, such as the position, speed, and acceleration of each surrounding vehicle from the detection result of the external environment recognition device 6. The position of each surrounding vehicle may be recognized as a representative point such as a center of gravity position or a corner positions of the surrounding vehicle, or an area represented by the contour of the surrounding vehicle.

The vehicle position recognition unit 41 recognizes a traveling lane, which is a lane in which the vehicle is traveling, and a relative position and an angle of the vehicle with respect to the traveling lane. The vehicle position recognition unit 41 may recognize the traveling lane according to the map information stored in the map storage unit 22 and the position of the vehicle acquired by the GNSS receiver 21. In addition, the lane markings drawn on the road surface around the vehicle may be extracted from the map information, and the relative position and angle of the vehicle with respect to the traveling lane may be recognized by comparing the extracted lane markings with the lane markings captured by the external camera 19.

The action plan unit 42 sequentially creates an action plan for driving the vehicle along the route. More specifically, the action plan unit 42 first determines a set of events for traveling on the target lane determined by the route determination unit 24 without the vehicle coming into contact with an obstacle. The events may include a constant speed traveling event in which the vehicle travels in the same lane at a constant speed, a preceding vehicle following event in which the vehicle follows a preceding vehicle at a certain speed which is equal to or lower than a speed selected by the driver or a speed which is determined by the prevailing environment, a lane changing event in which the vehicle change lanes, a passing event in which the vehicle passes a preceding vehicle, a merging event in which the vehicle merge into the traffic from another road at a junction of the road, a diverging event in which the vehicle travels into a selected road at a junction of the road, an autonomous driving end event in which autonomous driving is ended, and the driver takes over the driving operation, and a stop event in which the vehicle is brought to a stop when a certain condition is met, the condition including a case where the control unit 15 or the driver has become incapable of continuing the driving operation.

The conditions under which the action plan unit 42 invokes the stop event include the case where an input to the internal camera 26, the grip sensor 27, or the autonomous driving level switch 13 in response to an intervention request (a hand-over request) to the driver is not detected during autonomous driving. The intervention request is a warning to the driver to take over a part of the driving, and to perform at least one of the driving operation and the monitoring of the environment corresponding to the part of the driving that is to be handed over. The condition under which the action plan unit 42 invokes the stop even include the case where the action plan unit 42 has detected that the driver has become incapable of performing the driving while the vehicle is traveling due to a physiological ailment according to the signal from a pulse sensor, the internal camera or the like.

During the execution of these events, the action plan unit 42 may invoke an avoidance event for avoiding an obstacle or the like according to the surrounding conditions of the vehicle (existence of nearby vehicles and pedestrians, lane narrowing due to road construction, etc.).

The action plan unit 42 generates a target trajectory for the vehicle to travel in the future corresponding to the selected event. The target trajectory is obtained by sequentially arranging trajectory points that the vehicle should trace at each time point. The action plan unit 42 may generate the target trajectory according to the target speed and the target acceleration set for each event. At this time, the information on the target speed and the target acceleration is determined for each interval between the trajectory points.

The travel control unit 38 controls the power unit 3, the brake device 4, and the steering device 5 so that the vehicle traces the target trajectory generated by the action plan unit 42 according to the schedule also generated by the action plan unit 42. The storage unit 39 is formed by a ROM, a RAM, or the like, and stores information required for the processing by the autonomous driving control unit 35, the abnormal state determination unit 36, the state management unit 37, and the travel control unit 38.

The abnormal state determination unit 36 includes a vehicle state determination unit 51 and an occupant state determination unit 52. The vehicle state determination unit 51 analyzes signals from various devices (for example, the external environment recognition device 6 and the vehicle sensor 7) that affect the level of the autonomous driving that is being executed, and detects the occurrence of an abnormality in any of the devices and units that may prevent a proper execution of the autonomous driving of the level that is being executed.

The occupant state determination unit 52 determines if the driver is in an abnormal state or not according to a signal from the occupant monitoring device 11. The abnormal state includes the case where the driver is unable to properly steer the vehicle in autonomous driving of level 1 or lower that requires the driver to steer the vehicle. That the driver is unable to steer the vehicle in autonomous driving of level 1 or lower could mean that the driver is not holding the steering wheel, the driver is asleep, the driver is incapacitated or unconscious due to illness or injury, or the driver is under a cardiac arrest. The occupant state determination unit 52 determines that the driver is in an abnormal state when there is no input to the grip sensor 27 from the driver while in autonomous driving of level 1 or lower that requires the driver to steer the vehicle. Further, the occupant state determination unit 52 may determine the open/closed state of the driver's eyelids from the face image of the driver that is extracted from the output of the internal camera 26. The occupant state determination unit 52 may determine that the driver is asleep, under a strong drowsiness, unconscious or under a cardiac arrest so that the drive is unable to properly drive the vehicle, and the driver is in an abnormal condition when the driver's eyelids are closed for more than a predetermined time period, or when the number of times the eyelids are closed per unit time interval is equal to or greater than a predetermined threshold value. The occupant state determination unit 52 may further acquire the driver's posture from the captured image to determine that the driver's posture is not suitable for the driving operation or that the posture of the driver does not change for a predetermined time period. It may well mean that the driver is incapacitated due to illness or injury, and in an abnormal condition.

In the case of autonomous driving of level 2 or lower, the abnormal condition includes a situation where the driver is neglecting the duty to monitor the environment surrounding the vehicle. This situation may include either the case where the driver is not holding or gripping the steering wheel or the case where the driver's line of sight is not directed in the forward direction. The occupant state determination unit 52 may detect the abnormal condition where the driver is neglecting to monitor the environment surrounding the vehicle when the output signal of the grip sensor 27 indicates that the driver is not holding the steering wheel. The occupant state determination unit 52 may detect the abnormal condition according to the image captured by the internal camera 26. The occupant state determination unit 52 may use a per se known image analysis technique to extract the face region of the driver from the captured image, and then extracts the iris parts (hereinafter, iris) including the inner and outer corners of the eyes and pupils from the extracted face area. The occupant state determination unit 52 may detect the driver's line of sight according to the positions of the inner and outer corners of the eyes, the iris, the outline of the iris, and the like. It is determined that the driver is neglecting the duty to monitor the environment surrounding the vehicle when the driver's line of sight is not directed in the forward direction.

In addition, in the autonomous driving at a level where the drive is not required to monitor the surrounding environment or in the autonomous driving of level 3, an abnormal condition refers to a state in which the driver cannot promptly take over the driving when a driving takeover request is issued to the driver. The state where the driver cannot take over the driving includes the state where the system cannot be monitored, or, in other words, where the driver cannot monitor a screen display that may be showing an alarm display such as when the driver is asleep, and when the driver is not looking ahead. In the present embodiment, in the level 3 autonomous driving, the abnormal condition includes a case where the driver cannot perform the duty of monitoring the surrounding environment of the vehicle even though the driver is notified to monitor the surrounding environment of the vehicle. In the present embodiment, the occupant state determination unit 52 displays a predetermined screen on the display device 31 of the HMI 12, and instructs the driver to look at the display device 31. Thereafter, the occupant state determination unit 52 detects the driver's line of sight with the internal camera 26, and determines that the driver is unable to fulfill the duty of monitoring the surrounding environment of the vehicle if driver's line of sight is not facing the display device 31 of the HMI 12.

The occupant state determination unit 52 may detect if the driver is gripping the steering wheel according to the signal from the grip sensor 27, and if the driver is not gripping the steering wheel, it can be determined that the vehicle is in an abnormal state in which the duty of monitoring the surrounding environment the vehicle is being neglected. Further, the occupant state determination unit 52 determines if the driver is in an abnormal state according to the image captured by the internal camera 26. For example, the occupant state determination unit 52 extracts a driver's face region from the captured image by using a per se known image analysis means. The occupant state determination unit 52 may further extract iris parts (hereinafter, iris) of the driver including the inner and outer corners of the eyes and pupils from the extracted face area. The occupant state determination unit 52 obtains the driver's line of sight according to the extracted positions of the inner and outer corners of the eyes, the iris, the outline of the iris, and the like. It is determined that the driver is neglecting the duty to monitor the environment surrounding the vehicle when the driver's line of sight is not directed in the forward direction.

The state management unit 37 selects the level of the autonomous driving according to at least one of the own vehicle position, the operation of the autonomous driving level switch 13, and the determination result of the abnormal state determination unit 36. Further, the state management unit 37 controls the action plan unit 42 according to the selected autonomous driving level, thereby performing the autonomous driving according to the selected autonomous driving level. For example, when the state management unit 37 has selected the level 1 autonomous driving, and a constant speed traveling control is being executed, the event to be determined by the action plan unit 42 is limited only to the constant speed traveling event.

The state management unit 37 raises and lowers the autonomous driving level as required in addition to executing the autonomous driving according to the selected level.

More specifically, the state management unit 37 raises the level when the condition for executing the autonomous driving at the selected level is met, and an instruction to raise the level of the autonomous driving is input to the autonomous driving level switch 13.

When the condition for executing the autonomous driving of the current level ceases to be satisfied, or when an instruction to lower the level of the autonomous driving is input to the autonomous driving level switch 13, the state management unit 37 executes an intervention request process. In the intervention request process, the state management unit 37 first notifies the driver of a handover request. The notification to the driver may be made by displaying a message or image on the display device 31 or generating a speech or a warning sound from the sound generator 32. The notification to the driver may continue for a predetermined period of time after the intervention request process is started or may be continued until an input is detected by the occupant monitoring device 11.

The condition for executing the autonomous driving of the current level ceases to be satisfied when the vehicle has moved to an area where only the autonomous driving of a level lower than the current level is permitted, or when the abnormal state determination unit 36 has determined that an abnormal condition that prevents the continuation of the autonomous driving of the current level has occurred to the driver or the vehicle.

Following the notification to the driver, the state management unit 37 detects if the internal camera 26 or the grip sensor 27 has received an input from the driver indicating a takeover of the driving. The detection of the presence or absence of an input to take over the driving is determined in a way that depends on the level that is to be selected. When moving to level 2, the state management unit 37 extracts the driver's line of sight from the image acquired by the internal camera 26, and when the driver's line of sight is facing the front of the vehicle, it is determined that an input indicating the takeover of the driving by the driver is received. When moving to level 1 or level 0, the state management unit 37 determines that there is an input indicating an intent to take over the driving when the grip sensor 27 has detected the gripping of the steering wheel by the driver. Thus, the internal camera 26 and the grip sensor 27 function as an intervention detection device that detects an intervention of the driver to the driving. Further, the state management unit 37 may detect if there is an input indicating an intervention of the driver to the driving according to the input to the autonomous driving level switch 13.

The state management unit 37 lowers the autonomous driving level when an input indicating an intervention to the driving is detected within a predetermined period of time from the start of the intervention request process. At this time, the level of the autonomous driving after the lowering of the level may be level 0, or may be the highest level that can be executed.

The state management unit 37 causes the action plan unit 42 to generate a stop event when an input corresponding to the driver's intervention to the driving is not detected within a predetermined period of time after the execution of the intervention request process. The stop event is an event in which the vehicle is brought to a stop at a safe position (for example, an emergency parking zone, a roadside zone, a roadside shoulder, a parking area, etc.) while the vehicle control is degenerated. Here, a series of procedures executed in the stop event may be referred to as MRM (Minimum Risk Maneuver).

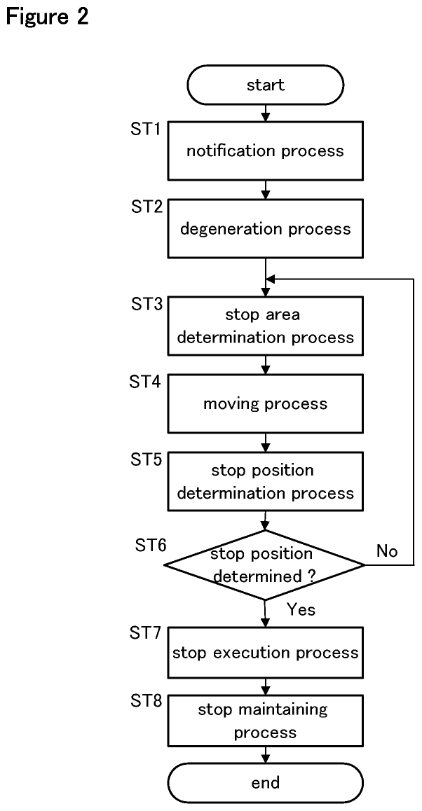

When the stop event is invoked, the control unit 15 shifts from the autonomous driving mode to the automatic stop mode, and the action plan unit 42 executes the stop process. Hereinafter, an outline of the stop process is described with reference to the flowchart of FIG. 2.

In the stop process, a notification process is first executed (ST1). In the notification process, the action plan unit 42 operates the external notification device 14 to notify the people outside of the vehicle. For example, the action plan unit 42 activates a horn included in the external notification device 14 to periodically generate a warning sound. The notification process continues until the stop process ends. After the notification process has ended, the action plan unit 42 may continue to activate the horn to generate a warning sound depending on the situation.

Then, a degeneration process is executed (ST2). The degeneration process is a process of restricting events that can be invoked by the action plan unit 42. The degeneration process may prohibit a lane change event to a passing lane, a passing event, a merging event, and the like. Further, in the degeneration process, the speed upper limit and the acceleration upper limit of the vehicle may be more limited in the respective events as compared with the case where the stop process is not performed.

Next, a stop area determination process is executed (ST3). The stop area determination process refers to the map information according to the current position of the own vehicle, and extracts a plurality of available stop areas (candidates for the stop area or potential stop areas) suitable for stopping, such as road shoulders and evacuation spaces in the traveling direction of the own vehicle. Then, one of the available stop areas is selected as the stop area by taking into account the size of the stop area, the distance to the stop area, and the like.

Next, a moving process is executed (ST4). In the moving process, a route for reaching the stop area is determined, various events along the route leading to the stop area are generated, and a target trajectory is determined. The travel control unit 38 controls the power unit 3, the brake device 4, and the steering device 5 according to the target trajectory determined by the action plan unit 42. The vehicle then travels along the route and reaches the stop area.

Next, a stop position determination process is executed (ST5). In the stop position determination process, the stop position is determined according to obstacles, road markings, and other objects located around the vehicle recognized by the external environment recognition unit 40. In the stop position determination process, it is possible that the stop position cannot be determined in the stop area due to the presence of surrounding vehicles and obstacles. When the stop position cannot be determined in the stop position determination process (No in ST6), the stop area determination process (ST3), the movement process (ST4), and the stop position determination process (ST5) are sequentially repeated.

If the stop position can be determined in the stop position determination process (Yes in ST6), a stop execution process is executed (ST7). In the stop execution process, the action plan unit 42 generates a target trajectory according to the current position of the vehicle and the targeted stop position. The travel control unit 38 controls the power unit 3, the brake device 4, and the steering device 5 according to the target trajectory determined by the action plan unit 42. The vehicle then moves toward the stop position and stops at the stop position.

After the stop execution process is executed, a stop maintaining process is executed (ST8). In the stop maintaining process, the travel control unit 38 drives the parking brake device according to a command from the action plan unit 42 to maintain the vehicle at the stop position. Thereafter, the action plan unit 42 may transmit an emergency call to the emergency call center by the communication device 8. When the stop maintaining process is completed, the stop process ends.

The vehicle control system 1 according to the present embodiment acquires the position of the obstacle and the relative speed of the obstacle with respect to the own vehicle according to a signal from the external environment recognition device 6 which is capable of acquiring the obstacle during automatic driving, and computes the position of each obstacle, and an obstacle presence region defined around each obstacle with a certain safety margin, at a plurality of future time points. The target trajectory of the own vehicle is determined so as not to overlap with the obstacle presence regions in terms of both time and space. A method of determining the safety margin and a method of creating a target trajectory are discussed in the following.

The external environment recognition unit 40 detects the position of an obstacle around the own vehicle and the speed of the obstacle according to a signal from the external environment recognition device 6. The obstacle includes a vehicle, a person, and a debris or cargo fell on the road. The vehicle includes a preceding vehicle and a following vehicle traveling in the same lane as the own vehicle, a vehicle traveling in a lane adjacent to the lane in which the own vehicle travels is traveling in the same traveling direction, and a vehicle traveling in an oncoming lane (an opposite lane). The person may be a pedestrian crossing the road.

The action plan unit 42 computes the position of the obstacle at each future time point according to the position and the speed of the obstacle acquired by the external environment recognition unit 40. Further, the action plan unit 42 computes an obstacle presence region defined around each obstacle with a certain safety margin. The safety margin refers to a distance to be maintained between the obstacle and the own vehicle at each future time point. The safety margin may be provided on the side of each obstacle facing the own vehicle at each time point. Each obstacle presence region may be defined as an extension of the position of the corresponding obstacle toward the own vehicle by the safety margin. The position of the obstacle at each future time point can be estimated from the current position of the obstacle and the current speed thereof. The acceleration of the obstacle may also be taken into account.

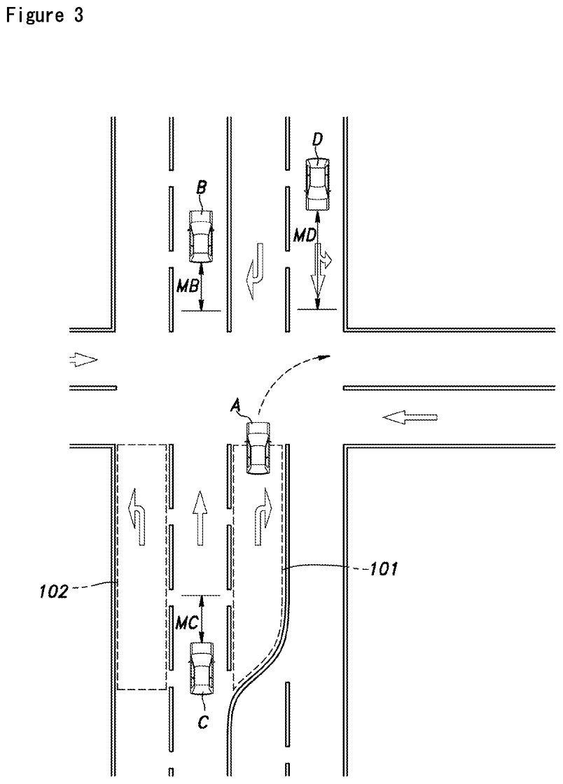

For example, as shown in FIG. 3, a safety margin MB is set for a vehicle B traveling in the same direction as the own vehicle A on the rear side of the vehicle B or on the front side of the own vehicle A along the lane. A safety margin MC is set for a vehicle C traveling behind the own vehicle in the same direction as the own vehicle in an adjacent lane along the lane on the front side of the vehicle C or behind the own vehicle. A safety margin MD is set for the vehicle D traveling in front of the own vehicle A in the oncoming lane along the lane on the front side of the vehicle D or on the front side of the own vehicle side. For a person crossing the lane, a safety margin is set on the front side of the own vehicle along the lane in which the own vehicle is traveling.

The action plan unit 42 may set the safety margin according to the state of the own vehicle, the type of the obstacle, the state of the obstacle, the type of the lane in which the own vehicle is traveling, and the like. The state of the own vehicle includes the vehicle speed and acceleration detected by the vehicle sensor 7, and may also include the distinction if the stop process is being executed among other possibilities. The type of the obstacle includes whether the obstacle is a vehicle, a person, a fallen object, or a structure. When the obstacle is a vehicle, the safety margin may differ depending on if the vehicle is traveling in the same direction or traveling in the opposite direction in an oncoming lane. The type of the lane may include the distinction if the road is a regular road or an expressway, and in the case of a regular road, may include a right-turn lane, a left-turn lane, and a straight-ahead lane. In other words, the action plan unit 42 may set the safety margin by taking into account the properties of each obstacle.

The action plan unit 42 may set the safety margin according to the time to collision (TTC) or the time headway (THW). The time to collision is a value obtained by dividing the distance between the own vehicle and the obstacle (surrounding vehicle) in the traveling direction of the own vehicle by the relative speed between the own vehicle and the obstacle. The time headway is a value obtained by dividing the distance between the own vehicle and the preceding vehicle in the traveling direction of the own vehicle by the speed of the own vehicle. For example, the action plan unit 42 may reduce the safety margin as the time to collision or the time headway increases.

In particular, the action plan unit 42 may increase the safety margin during the execution of the stop process than in other times. For example, the action plan unit 42 may increase the safety margin by multiplying a factor greater than one to the safety margin during the execution of the stop process, as opposed to the case where the stop process is not being executed. In addition, the action plan unit 42 may increase the safety margin by adding a predetermined value to the safety margin during the execution of the stop process, as opposed to the case where the stop process is not being executed.

The action plan unit 42 creates a target trajectory of the own vehicle so as not to overlap with the obstacle presence region of each obstacle which typically consists of a surrounding vehicle. Therefore, as the safety margin is increased, the target trajectory is created such that the own vehicle travels farther from each obstacle. As a result, a larger distance is secured between the own vehicle and each obstacle so that the possibility of collision between the own vehicle and the obstacle is reduced. As a result, the vehicle can travel more safely.

For example, when making a right turn at an intersection, the action plan unit 42 estimates the obstacle presence region of the preceding vehicle that is expected to make a right turn ahead of the own vehicle at each future time point, and each oncoming vehicle traveling in the oncoming lane at each future time point. By taking into such eventualities, a right turn target trajectory is created so as not to overlap with the obstacle presence region of each vehicle at each future time point.

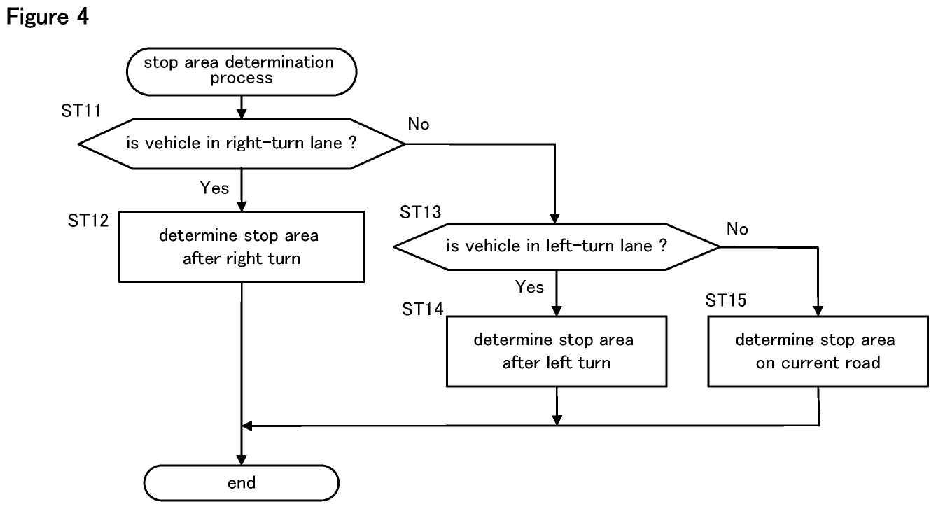

Details of the above-described stop area determination process (ST3) are discussed in the following with reference to FIGS. 3 and 4. The following discussion will be based on left-hand traffic. In other words, the lane for crossing the oncoming lane is a right-turn lane. In regions where right-hand traffic is adopted, the lane for crossing the oncoming lane will be a left-turn lane. The lane for crossing the oncoming lane is a lane in which the vehicle should travel before crossing the oncoming lane, and is provided within a predetermined distance from the intersection. The lane for crossing the oncoming lane may be a region within 50 m from the intersection. The lane for crossing the oncoming lane may be either strictly for vehicles which are about to cross the oncoming lane, or shared by vehicles which are going to travel straight ahead through the intersection. The same is true with lanes for a left turn in left-hand traffic, and lanes for a right turn in right-hand traffic.

As shown in FIG. 4, the action plan unit 42 first determines if the current position of the own vehicle is in the lane for crossing the oncoming lane, or in the right-turn lane 101 (ST11). The right-turn lane 101 is a lane having a predetermined length from the intersection (see FIG. 3), and is stored in the map storage unit 22 as a part of the map information. This right-turn lane 101 is on the route to a preset destination. The action plan unit 42 uses the navigation device 9 to determine if the vehicle position is in the right-turn lane 101.

When the own vehicle is in the right-turn lane 101 (Yes in ST11), the action plan unit 42 refers to the map information and extracts a plurality of available stop areas such as road shoulders and evacuation spaces on the road after turning right at the intersection. Then, a final stop area is determined from the available stop areas according to the size of the stop area, the distance between the stop area and the current position of the own vehicle, and the like (ST12).

When the own vehicle is not in the right-turn lane 101 (No in ST11), it is determined if the current position of the own vehicle is in the lane for turning left, or, in other words, in the left-turn lane 102 (ST13). The left-turn lane 102 is a lane having a predetermined length from the intersection (see FIG. 3), and is stored in the map storage unit 22 as a part of the map information. The left-turn lane 102 is on the route to a preset destination. The action plan unit 42 uses the navigation device 9 to determine if the own vehicle position is within the left-turn lane 102.

When the vehicle is in the left-turn lane 102 (Yes in ST13), the action plan unit 42 refers to the map information and extracts a plurality of available stop areas such as road shoulders and evacuation spaces on the road after turning left at the intersection. Then, a stop area is determined from the available stop areas according to the size of the stop area, the distance between the stop area and the own vehicle position, and the like (ST14).

When the own vehicle is not in the left-turn lane 102 (No in ST13), the action plan unit 42 refers to the map information and extracts a plurality of available stop areas such as road shoulders and evacuation spaces on the road on which the own vehicle is currently traveling. Then, a stop area is determined from the available stop areas according to the size of the stop area, the distance between the stop area and the own vehicle position, and the like (ST15). At this time, the action plan unit 42 sets the stop area in a range excluding the lanes 101 and 102 for the vehicle to turn right or left. After the stop area is determined in any of steps ST12, ST14, and ST15, the stop area determination process ends.

According to the stop area determination process described above, the action plan unit 42 determines the stop area such that the stop area is on the route to a preset destination and the number of times of crossing (turning right) the oncoming lane is no more than once. Alternatively or additionally, in the stop process, the action plan unit 42 sets the stop area on the route to a preset destination and in a range where the number of right or left turns is no more than one.

In the stop process, when a right turn occurs, the vehicle is in the right-turn lane 101 when the stop area determination process is executed. Therefore, the number of right turns is limited to one at most. Similarly, in the stop process, when a left turn occurs, the vehicle is in the left-turn lane 102 when the stop area determination process is executed. Therefore, the number of left turns is limited to one at most. Thereby, the probability of occurrence of an accident in the stop process can be further reduced.

If the vehicle is in the right-turn lane 101 when executing the stop area determination process, the stop area is set on the part of the road on which the own vehicle will be traveling after the right turn. In other words, the vehicle comes to a stop after leaving the right-turn lane 101. Similarly, if the vehicle is in the left-turn lane 102 when executing the stop area determination process, the stop area is set on the part of the road on which the own vehicle will be traveling after the left turn. In other words, the vehicle comes to a stop after leaving the left-turn lane 102. Thereby, the probability of obstructing the traffic of other vehicles using the right-turn lane 101 or the left-turn lane 102 by the own vehicle coming to a stop as a result of the stop process can be minimized.

If the vehicle is not in the right-turn lane 101 or the left-turn lane 102 when executing the stop area determination process, the stop area is set on a part of the road on which the vehicle is currently traveling, particularly at some distance ahead of the intersection if the vehicle is in an intersection or about to enter an intersection. According to this arrangement, since the vehicle does not make a right turn or a left turn, the probability of occurrence of an accident can be further reduced. Further, at this time, the stop area is set in a range excluding the right-turn lane 101 or the left-turn lane 102 so that the vehicle can be stopped at a position where the traffic of other right turn vehicles or left turn vehicles is not obstructed.

The action plan unit 42 defines a larger safety margin when the stop process is being executed than when the stop process is not being executed so that the possibility of collision with an obstacle can be further reduced. In a situation in where the action plan unit 42 is executing the stop process, the driver's intervention in driving or monitoring of the surrounding environment cannot be expected. When the safety margin increased, the own vehicle is enabled to travel while maintaining a larger distance from obstacles such as surrounding vehicles. Therefore, in a situation where the vehicle stop process is being executed, the vehicle can be driven autonomously more safely by increasing the safety margin. As a result, even a right turn or a left turn can be performed relatively safely.

In addition, the vehicle speed when making a right turn may be lower when the stop process is being executed than when the stop process is not being executed. According to this arrangement, since other vehicles can easily avoid the own vehicle, the possibility of occurrence of an accident can be further reduced.

The present invention has been described in terms of a specific embodiment, but is not limited by such an embodiment, but can be modified in various ways without departing from the scope of the present invention. In the above embodiment, it was assumed that the vehicle is traveling in a country or a region of left-hand traffic, but the present invention is not limited to this. When the vehicle is traveling in a country or a region of right-hand traffic, the vehicle control system 1 may control the vehicle in such a manner that the left and right are interchanged in the above description.

1. A vehicle control system, comprising:
a control unit configured to control a vehicle according to a degree of intervention in driving by a driver, the intervention in driving including steering, accelerating, and decelerating vehicle, and monitoring an environment surrounding the vehicle; and
an external environment recognition device configured to detect an obstacle located around the vehicle;
wherein the control unit acquires a position and a speed of the obstacle according to a signal from the external environment recognition device,
computes a position of the obstacle at each of a plurality of time points in future, and an obstacle presence region defined around the obstacle with a prescribed safety margin at each time point,
determines a future target trajectory of the vehicle so as not to overlap with the obstacle presence region, and
executes a stop process to bring the vehicle to a stop in a prescribed stop area when an input from the driver has failed to be detected in spite of an intervention request from the control system to the driver,
the safety margin being greater when executing the stop process than when not executing the stop process.

2. The vehicle control system according to claim 1, wherein in the stop process, the control unit determines the stop area on a planned route to a destination such that the vehicle crosses an oncoming lane no more than once.

3. The vehicle control system according to claim 2, wherein when the vehicle is traveling in a lane for crossing the oncoming lane, and a stop process is initiated, the control unit determines the stop area in a part of the route beyond the oncoming lane that is to be crossed.

4. The vehicle control system according to claim 2, wherein the control unit controls a vehicle speed to be slower when the vehicle crosses the oncoming lane in the stop process than when the vehicle crosses the oncoming lane not in the stop process.

5. The vehicle control system according to claim 2, wherein in executing the stop process, when the vehicle is not in a lane for crossing an oncoming lane, the control unit determines the stop area in a part of the route to the destination not crossing the oncoming lane.

6. The vehicle control system according to claim 5, wherein in executing the stop process, the control unit determines the stop area in a range on the route to the destination excluding a lane for crossing the oncoming lane.

7. The vehicle control system according to claim 1, wherein in executing the stop process, the control unit determines the stop area in a range on a planned route to a destination such that there is no more than one left turn or one right turn.

8. The vehicle control system according to claim 7, wherein in executing the stop process, when the vehicle is in a lane for turning right or left, the control unit determines the stop area on a part of a road located beyond a part where the vehicle makes a right or left turn.

9. The vehicle control system according to claim 8, wherein in executing the stop process, the control unit determines the stop area in a part of the road along which the vehicle is currently traveling if the vehicle is not in a lane for making a left turn or a right turn.

10. The vehicle control system according to claim 9, wherein in executing the stop process, the control unit determines the stop area in a range excluding a lane for the vehicle to make a right or left turn.
